(19) United States
(12) Patent Application Publication
(10) Pub. No.: US 2026/0143395 A1
(43) Pub. Date: May 21, 2026

(54) METHOD FOR CELL HANDOVER AND COMMUNICATION DEVICE

(71) Applicant: Beijing Xiaomi Mobile Software Co., Ltd., Beijing (CN)

(72) Inventors: Xiaolong LI, Beijing (CN); Xingyi LUO, Beijing (CN)

(73) Assignee: Beijing Xiaomi Mobile Software Co., Ltd., Beijing (CN)

(21) Appl. No.: 19/157,031

(22) PCT Filed: Feb. 17, 2023
(86) PCT No.: PCT/CN2023/076987

§ 371 Date: Aug. 15, 2025

(51) Int. Cl. H04W 36/08; H04W 36/00

(52) U.S. Cl. CPC H04W 36/085; H04W 36/0072

(57) ABSTRACT

Provided in the present disclosure are a method for a cell handover, a communication apparatus, a communication device, and a computer storage medium. The method is applied to a user equipment in a communication system. The method includes: acquiring configuration information of a target cell, where the configuration information is configured for the user equipment to hand over to the target cell.

### CROSS-REFERENCE TO RELATED APPLICATIONS

The present application is a U.S. National Stage of International Application No. PCT/CN 2023/076987, filed on Feb. 17, 2023, the entire content of which is incorporated herein by reference for all purposes.

### TECHNICAL FIELD

The present disclosure relates to a field of wireless communication technologies, and in particular, to a method for a cell handover, a communication apparatus, a communication device, and a computer storage medium.

### BACKGROUND

In non-terrestrial network (NTN) communications, satellites typically use regional beams (or wide beams) to provide wide coverage with low power and low signal-to-noise ratio. In addition, the satellites typically use localized beams (or narrow beams) to provide local coverage with high power and high signal-to-noise ratio.

### SUMMARY

The present disclosure provides a method for a cell handover, a communication apparatus, a communication device, and a computer storage medium.

According to a first aspect of the present disclosure, a method for a cell handover is provided, which may be applied to a user equipment in a communication system. The method includes: acquiring configuration information of a target cell, where the configuration information is configured for the user equipment to hand over to the target cell.

According to a second aspect of the present disclosure, a method for a cell handover is provided, which may be applied to a network device in a communication system. The method may include: sending configuration information of a target cell, where the configuration information is configured for the user equipment to hand over to the target cell.

According to a third aspect of the present disclosure, a communication device, such as user equipment, is provided. The communication device includes: an antenna; a memory; and a processor, where the processor is connected to the antenna and the memory, respectively, and configured to control transmission and reception of the antenna by executing computer-executable instructions stored in the memory, and to implement the method for the cell handover according to any of the first aspect and embodiments thereof as disclosed herein.

According to a fourth aspect of the present disclosure, a communication device, such as a network device, is provided. The communication device includes: an antenna; a memory; and a processor, where the processor is connected to the antenna and the memory, respectively, and configured to control transmission and reception of the antenna by executing computer-executable instructions stored in the memory, and to implement the method for the cell handover according to any of the second aspect and embodiments thereof as disclosed herein.

### BRIEF DESCRIPTION OF THE DRAWINGS

FIG. 1 is a schematic diagram of a communication system according to an embodiment of the present disclosure;

FIG. 2 is a schematic diagram of a first implementation flow of a method for a cell handover performed on a user equipment side according to an embodiment of the present disclosure;

FIG. 3 is a schematic diagram of a second implementation flow of a method for a cell handover performed on a user equipment side according to an embodiment of the present disclosure;

FIG. 4 is a schematic diagram of a third implementation flow of a method for a cell handover performed on a user equipment side according to an embodiment of the present disclosure;

FIG. 5 is a schematic diagram of a first implementation flow of a method for a cell handover performed on a network device side according to an embodiment of the present disclosure;

FIG. 6 is a schematic diagram of a second implementation flow of a method for a cell handover performed on a network device side according to an embodiment of the present disclosure;

FIG. 7 is a schematic diagram of a third implementation flow of a method for a cell handover performed on a network device side according to an embodiment of the present disclosure;

FIG. 8 is a schematic diagram of an implementation flow of a method for a cell handover performed in a communication system according to an embodiment of the present disclosure;

FIG. 9 is a schematic diagram of a first structure of a communication apparatus according to an embodiment of the present disclosure;

FIG. 10 is a schematic diagram of a second structure of a communication apparatus according to an embodiment of the present disclosure;

FIG. 11 is a schematic diagram of a communication device according to an embodiment of the present disclosure;

FIG. 12 is a schematic diagram of user equipment according to an embodiment of the present disclosure;

FIG. 13 is a schematic diagram of a network device according to an embodiment of the present disclosure.

### DETAILED DESCRIPTION

The exemplary embodiments will be described in detail herein, with examples illustrated in the accompanying drawings. In the following description referring to the drawings, unless otherwise indicated, the same numerals in different drawings represent the same or similar elements. The embodiments described in the following exemplary embodiments do not represent all embodiments consistent with the present disclosure. Rather, they are merely examples of devices and methods consistent with some aspects of the embodiments of the present disclosure.

The embodiments or examples of the present disclosure are not exhaustive and are merely schematic representations of some embodiments or examples, which are not construed as specific limitations to the protection scope of the present disclosure. Unless otherwise contradictory, each step in an embodiment or example may be implemented as an independent embodiment, and respective steps may be combined in any manner. For example, a solution with some steps removed in a certain embodiment or example may also be implemented as an independent embodiment; order of the steps in a certain embodiment or example may also be exchanged arbitrarily. In addition, optional modes or optional examples in a certain embodiment or example may be combined in any manner; moreover, the various embodiments or examples may be combined arbitrarily. For example, some or all steps of different embodiments or examples may be combined in any manner, and a certain embodiment or example may be combined with an optional mode or an optional example of another embodiment or example in any manner.

The terms used in the embodiments of the present disclosure are merely for the purpose of describing specific embodiments, and are not intended to limit the embodiments of the present disclosure. The singular form “a” and “the” as used in the embodiments of the present disclosure is also intended to include the plural form, unless the context clearly indicates otherwise. It should also be understood that the term “and/or” as used herein refers to and includes any or all possible combinations of one or more of the associated listed items.

It should be understood that although the embodiments of the present disclosure may use the terms “first”, “second”, “third”, etc., to describe various information, such information should not be limited to these terms. These terms are only used to distinguish information of the same type from each other. For example, without departing from the scope of the embodiments of the present disclosure, “first information” may also be referred to as “second information”, and similarly, “second information” may also be referred to as “first information”. Depending on the context, the term “if” as used herein may be interpreted as “when . . . ”, “upon . . . ”, “in response to . . . ”, or “in a case that . . . ”, and may be used interchangeably provided no contradiction arises.

In the description of the embodiments of the present disclosure, the expressions “A or B”, “A and/or B”, “at least one of A and B”, “in one case A, in another case B”, “in response to one case A, in response to another case B”, and the like may include at least one of the following technical solutions as the case may be: performing A regardless of B, i.e., in some embodiments or examples, A is performed; performing B regardless of A, i.e., in some embodiments or examples, B is performed; selectively performing A or B, i.e., in some embodiments or examples, one of A and B is selected and performed; performing both A and B, i.e., in some embodiments or examples, both A and B are performed.

In the description of the embodiments of the present disclosure, “including A”, “containing A”, “configured to indicate A”, and “carrying A” may be interpreted as directly carrying A, or may be interpreted as indirectly indicating A.

The technical solutions provided in the embodiments of the present disclosure may be applied to wireless communication between communication devices. The wireless communication between communication devices may include: wireless communication between a network device and a user equipment, wireless communication between network devices, and wireless communication between user equipment. In the embodiments of the present disclosure, the term “wireless communication” may also be abbreviated as “communication”, and the term “communication” may also be described as “data transmission”, “information transmission”, or “transmission”.

The embodiments of the present disclosure list a plurality of embodiments to clearly illustrate the technical solutions of the embodiments of the present disclosure. Of course, those skilled in the art may understand that the plurality of embodiments provided by the embodiments of the present disclosure may be executed individually, may also be executed in combination with methods of other embodiments in the embodiments of the present disclosure, or may be executed individually or in combination with some other methods in related art. The embodiments of the present disclosure are not limited thereto.

The technical solutions of the embodiments of the present disclosure are applicable to a communication system that integrates terrestrial communication and non-terrestrial communication. In an embodiment, the non-terrestrial communication system may also be referred to as a non-terrestrial network (NTN) communication system, such as a satellite system. For example, the above-mentioned terrestrial communication system may be based on a Long Term Evolution (LTE) system, a Universal Mobile Telecommunication System (UMTS), a 5G communication system, a New Radio (NR) system, a future next-generation mobile communication system, etc. The embodiments of the present disclosure are not specifically limited thereto. In an embodiment, the communication system in the embodiments of the present disclosure is described by taking the integration of a satellite system and a 5G communication system as an example.

In wireless communication technology, satellite communication is considered to be an important aspect in the development of future wireless communication technology. Satellite communication refers to the communication carried out by radio communication equipment on the ground using satellites as relays. The satellite communication system consists of a satellite part and a ground part. The characteristics of satellite communication are: large communication range; communication between any two points may be carried out as long as they are within the range covered by the radio waves emitted by the satellite; it is not easily affected by land disasters and has high reliability.

As a supplement to the ground communication system, satellite communication has the following characteristics: 1. coverage may be extended: for areas where the cellular communication system cannot cover or the coverage cost is high, such as oceans, deserts and remote mountainous areas, satellite communication may be used to solve the problem of communication. 2. Emergency communication: under the condition that the infrastructure of cellular communication is unavailable due to the extreme situation of disaster (such as earthquake, etc.), the use of satellite communication may quickly establish a communication connection. 3. Provide industry applications: for example, for delay-sensitive services of long-distance transmission, satellite communication may be used to reduce the delay of service transmission.

Satellite communication may be the communication between radio communication stations on the ground using communication satellites as relay stations to forward radio waves. The communication function of the communication satellite includes: receiving a signal, changing the frequency of the signal, amplifying the signal, forwarding the signal and positioning.

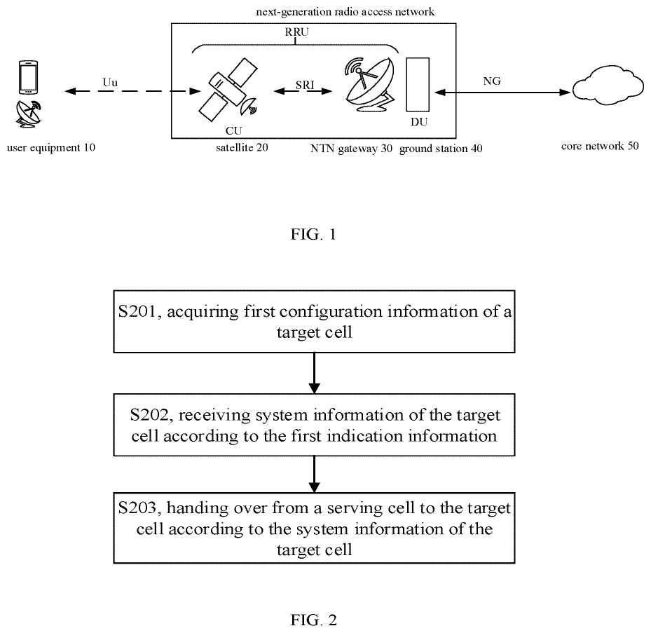

The embodiments of the present disclosure provide a communication system, and the communication system integrates an NTN system and a terrestrial communication system. In an embodiment, the NTN system may take a satellite system as an example. FIG. 1 is a schematic diagram of a communication system according to an embodiment of the present disclosure. Referring to FIG. 1, the communication system may include: a user equipment (UE) 10, a satellite 20, an NTN gateway 30, a ground station 40, and a core network 50. The access network function may be deployed using a centralized unit (CU) and a distributed unit (DU) architecture (i.e., CU-DU architecture). In this case, the DU may be carried on the satellite 20 (e.g., a payload carried by the satellite 20), and the CU is deployed on the ground station 40 (e.g., a gNB). The satellite 20 and the NTN gateway 30 form a remote radio unit (RRU). Thus, the satellite 20, the NTN gateway 30, and the ground station 40 constitute a next-generation radio access network (RAN), which is used to implement the access network function. The satellite 20, the NTN gateway 30, and the ground station 40 may be considered as the access network device. In an embodiment, the user equipment 10 is connected to the satellite 20 through a New Radio interface (e.g., Uu interface), the satellite 20 communicates with the NTN gateway 30 through an interface (e.g., SRI), and the ground station 40 communicates with the core network 50 through a wireless link interface (e.g., NG interface). In this way, the DU in the air establishes a wireless feeder link with the CU on the ground via the NTN gateway on the ground.

It should be noted that the satellite 20 in FIG. 1 may be a non-geostationary Earth satellite such as a low earth orbit (LEO) satellite, a medium earth orbit (MEO) satellite, etc. Of course, the satellite 20 may also be replaced by another airborne platform determined by an orbital path, such as an unmanned aerial vehicle (UAV), a balloon, an airplane, etc. Further, in an embodiment, the satellite 20 may also be replaced by another ground platform determined by a movement path, such as a bus or a ship with fixed route. The embodiments of the present disclosure are not specifically limited thereto.

It should be understood that FIG. 1 is merely an example of a communication system. The technical solutions of the embodiments disclosed herein may also be applied to another communication system that integrates the terrestrial communication and the non-terrestrial communication. The embodiments of the present disclosure are not specifically limited thereto.

In some embodiments, the user equipment 10 may be a device that provides voice or data connectivity to a user. In an embodiment, the user equipment 10 may also be referred to as a terminal device, a mobile station, a subscriber unit, a station, or terminal equipment (TE), etc. In an embodiment, the user equipment 10 may also be a handheld device or in-vehicle device with wireless connectivity. For example, some examples of the user equipment 10 may include: a mobile phone, a tablet, a laptop, a handheld computer, a mobile internet device (MID), a wearable device, a virtual reality (VR) device, an augmented reality (AR) device, a wireless terminal in industrial control, a wireless terminal in auto-driving, a wireless terminal in remote medical surgery, a wireless terminal in smart grid, a wireless terminal in transportation safety, a wireless terminal in smart city, a wireless terminal in smart home, a cellular phone, a cordless phone, a session initiation protocol (SIP) phone, a wireless local loop (WLL) station, a personal digital assistant (PDA), a handheld device with wireless communication capability, a computing device or other processing device connected to a wireless modem, an in-vehicle device, a wearable device, a user equipment in a 5G network, or a user equipment in an evolved public land mobile network (PLMN), etc. The embodiments of the present disclosure are not specifically limited thereto.

In some embodiments, the above-mentioned ground station may be a device in the Radio Access Network (RAN), or in other words, a RAN node that connects the user equipment to the wireless network. For example, some examples of the ground station include: a gNB, a transmission reception point (TRP), an evolved node B (eNB), a radio network controller (RNC), a node B (NB), a base station controller (BSC), a base transceiver station (BTS), a home evolved node B (HeNB) or a home node B (HNB), a base band unit (BBU), a wireless fidelity (Wi-Fi) access point (AP), etc.

The following describes a solution for a cell handover provided by the present disclosure in conjunction with the above communication system.

The embodiment of the present disclosure provides a method for a cell handover. FIG. 2 is a schematic diagram of a first implementation process of the method for the cell handover performed on the user equipment side in the embodiment of the present disclosure. The method for the cell handover may be applied to the user equipment in the communication system described above. Referring to FIG. 2, the method for the cell handover may include S201.

S201, acquiring first configuration information of a target cell.

The first configuration information includes first indication information, and the first indication information is configured to indicate the user equipment to acquire system information of the target cell.

In an embodiment, the first configuration information may be sent to the user equipment by a serving cell, or the first configuration information may be sent to the user equipment by a network device via the serving cell.

In an embodiment, the first configuration information may be carried in a high-layer signaling and sent to the user equipment, such as at least one of a radio resource control (RRC) signaling, a broadcast message, a system message, a medium access control (MAC) control element (CE), downlink control information (DCI), and a signaling carried by a physical downlink shared channel (PDSCH). Of course, the first configuration information may also be sent in another signaling. The embodiments of the present disclosure are not specifically limited thereto. For example, the first indication information is carried in the DCI and sent to the user equipment to achieve flexible configuration of beam training.

In some cases, the first configuration information may be sent separately by the network device, or may be sent together when the network device sends other information. For example, the first configuration information may be sent together with the configuration information of a reference signal sent by the network device.

In an embodiment, the above-mentioned system information may be one or more system information (SI) for the cell handover. For example, the system information may include a system information block (SIB) 19. SIB 19 includes satellite assistance information, such as ephemeris data, a public timing advance (TA) parameter, a koffset, a validity period of uplink synchronization information, an epoch time, and the like. Of course, the above system information may also include other SIBs, such as SIB1, SIBx, etc. The embodiments of the present disclosure are not specifically limited thereto.

In an embodiment, the first indication information is configured to indicate the user equipment to acquire SIB19.

In some embodiments, still referring to FIG. 2, after S201, the user equipment may further perform S202 to S203.

S202, receiving system information of the target cell according to the first indication information.

S203, handing over from a serving cell to the target cell according to the system information of the target cell.

In an embodiment, after acquiring the first indication information through S201, the user equipment may respond to the indication and receive the system information of the target cell by means such as a broadcast message or a system message. Then, the user equipment performs uplink synchronization according to the system information, and after completing the uplink synchronization, hands over from the serving cell to the target cell. Thus, the user equipment completes the process of cell handover. In the embodiment of the present disclosure, the user equipment is triggered by the first indication information to acquire the system information of the target cell, and performs the uplink synchronization with the target cell according to the system information, eventually handing over to the target cell. It may be seen that the user equipment does not need to initiate a random access procedure to the target cell when performing the cell handover, thereby saving system signaling overhead.

In an embodiment, due to the high-speed movement of the satellite, the system information of the target cell may change. Therefore, before performing the cell handover, the user equipment needs to acquire the latest system information of the target cell in order to achieve the uplink synchronization with the target cell and complete the cell handover. In an embodiment, the above-mentioned first configuration information may further include time information (i.e., second time information), which is used to indicate a time point (i.e., second time point), a time period (i.e., second time period), or a combination of the second time point and the second time period for the user equipment to acquire the system information of the target cell. In S202, the user equipment responds to the first indication information and receives the system information of the target cell according to the second time point or the second time period. For example, the second time point may be a start time point, an end time point, or both start and end time points for the user equipment to acquire the system information of the target cell. The second time period may be a time period during which the user equipment may acquire the system information of the target cell.

In some cases, the second time information may include the start time point at which the user equipment acquires the system information of the target cell, and then, the user equipment may start receiving the system information of the target cell at the start time point. Alternatively, the second time information may include the end time point at which the user equipment acquires the system information of the target cell, the user equipment determines the start time point at which the user equipment starts to receive the system information of the target cell according to the end time point, and receives the system information of the target cell at the start time point. Alternatively, the second time information may include both the start time point and the end time point for the user equipment to acquire the system information of the target cell, the user equipment may determine the time period (i.e., second time period) used for acquiring the system information of the target cell according to the start time point and the end time point, and acquire the system information of the target cell during this time period. In some cases, the second time information may include the time period during which the user equipment acquires the system information of the target cell, and thus the user equipment may acquire the system information of the target cell during the second time period. In some cases, the second time information may include at least one of the above-mentioned start time point, end time point, or time period. In an embodiment, the start time point and the end time point may be start and end time points of the time period, or any time point within the time period. The user equipment may acquire the system information of the target cell during the time period according to the start time point or the end time point. Of course, the second time information may also include other time information related to acquiring the system information of the target cell. Correspondingly, the user equipment may also acquire the system information of the target cell according to the second time information in other manners. The embodiments of the present disclosure are not specifically limited thereto.

In an embodiment, the above-mentioned second time information may also be carried in at least one of an RRC signaling, a broadcast message, a system message, a Medium Access Control Control Element (MAC CE), DCI, and a signaling carried by a PDSCH for transmission. For example, the second time information is carried in the DCI for transmission.

In an embodiment, the respective pieces of information in the first configuration information may be carried in the same signaling for transmission or may be carried in different signaling for transmission. In some cases, the various pieces of information carried in different signaling may be transmitted simultaneously or multiple times. The embodiments of the present disclosure do not place any particular limitation on the manner in which the first configuration information is sent.

In an embodiment, after S203, the user equipment may further indicate to the target cell that the handover has been completed. In this case, the user equipment may send uplink information to the target cell, where the uplink information is used to indicate that the user equipment completes the cell handover.

In an embodiment, the above-mentioned uplink information may be uplink control information, uplink data, and the like. For example, when there is no uplink data, the user equipment may, after handing over to the target cell, send uplink control information to the network device, such as handover response information or handover complete information, to indicate that the user equipment completes the cell handover. Alternatively, when there is uplink data, the user equipment may, after handing over to the target cell, send uplink data to the network device to indicate that the user equipment completes the cell handover. Alternatively, the user equipment may, after handing over to the target cell, first send the uplink control information to the network device to indicate the network device that the handover has been completed, and then send the uplink data to the network device when the uplink data arrives. Thus, the user equipment completes the process of the cell handover.

In an embodiment, the serving cell and the target cell of the user equipment may be cells managed by the same network device (e.g., ground station), or may be cells managed by different network devices. In some cases, different cells may communicate with the user equipment via different satellites, that is, the serving cell and the target cell may be served by different satellites. Of course, other deployment configurations of cells may also exist, and the present disclosure does not specifically limit this.

In an embodiment, the serving cell and the target cell of the user equipment may have the same Physical Cell Indicator (PCI), or the serving cell and the target cell of the user equipment may have different PCIs.

In the embodiments of the present disclosure, the serving cell (or source cell) and the target cell of the user equipment are served by different satellites, and the target cell and the serving cell share the same PCI. When the user equipment hands over from the serving cell to the target cell, due to the same PCI, the user equipment may determine only a beam handover is performed, that is, the user equipment thinks that the system information broadcast by the cell has not changed. Therefore, when the system information (e.g., SIB19) broadcast by the serving cell remains valid, the user equipment does not reacquire the system information. However, in fact, the system information of the target cell may have already changed (as the target and serving cells belong to two different satellites). Therefore, in the case that the current system information of the serving cell remains valid or unchanged, the serving cell needs to indicate to the user equipment to acquire the system information of the cell, such that the user equipment may perform the cell handover according to valid system information, so as to successfully hand over to the target cell.

It should be noted that the embodiment of S201 described above may be executed independently. The embodiment of S201 may also be executed in combination with the embodiments of S202 to S203. The embodiment of S201, the embodiments of S202 to S203, and the step in which the user equipment sends uplink information may be executed in combination. Each of the steps in the above embodiments may be executed independently or in combination. Unless otherwise contradictory, the execution order of the respective steps may be freely exchanged.

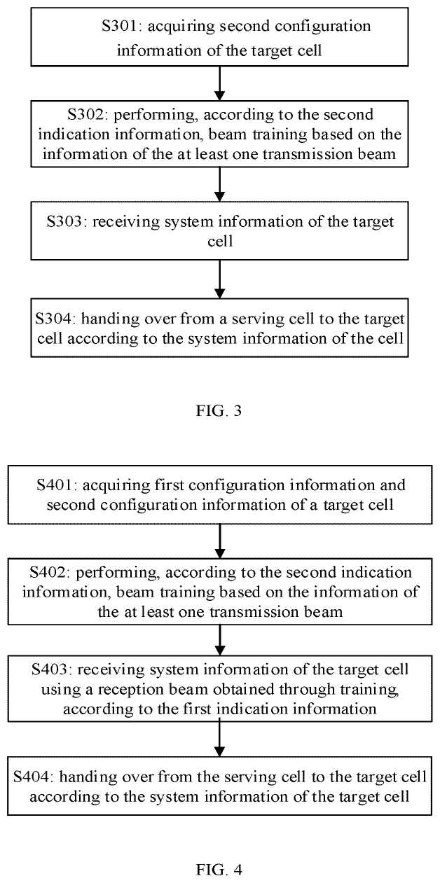

In some embodiments, FIG. 3 is a schematic diagram illustrating a second embodiment of the method for the cell handover performed at the user equipment side according to the present disclosure. The method for the cell handover may be applied to the user equipment of the communication system described above. Referring to FIG. 3, the method for the cell handover may include S301.

S301: acquiring second configuration information of the target cell.

The second configuration information includes information of at least one transmission beam of the target cell and second indication information, where the second indication information is configured to indicate the user equipment to perform beam training based on the information of the at least one transmission beam.

In an embodiment, the second configuration information may be sent to the user equipment by the serving cell or may be sent to the user equipment by the network device via the serving cell.

In an embodiment, the information of the at least one transmission beam of the target cell may include configuration information of at least one reference signal of the target cell. The reference signal may be used for the user equipment to perform the beam training, and the reference signal may also be referred to as a training signal. In an embodiment, the at least one reference signal is sent by the target cell using the at least one transmission beam. In this case, the at least one transmission beam may be a wide beam or a beam with broad coverage.

In an embodiment, the above-mentioned reference signal may be a Synchronization Signal (SS) or a Channel Status Information Reference Signal (CSI-RS) in the target cell. For example, when the user equipment is in an idle state, the beam training may be performed using the SS. When the user equipment is in a connected state, the beam training may be performed using the CSI-RS. Of course, in some cases, the reference signal may also be another signal sent using the transmission beam of the target cell, as long as the signals may be used for the beam training, which is not specifically limited by the embodiments of the present disclosure.

In an embodiment, the configuration information of the reference signal may include configuration information of the SS, such as configuration information of a Synchronization Signal Block (SSB), or configuration information of the CSI-RS. For example, the configuration information of the reference signal may include at least one of: an SSB index and an SSB parameter; or a CSI-RS index and a CSI-RS parameter.

In an embodiment, the second configuration information may be carried in high-layer signaling for transmission to the user equipment, such as at least one of an RRC signaling, broadcast messages, a system message, an MAC CE, DCI, and a signaling carried by a PDSCH. Of course, the second configuration information may also be carried in another signaling for transmission, which is not specifically limited by the embodiments of the present disclosure.

For example, the information of the at least one transmission beam may be carried in at least one of the RRC signaling, the broadcast message, the system message, the MAC CE, the DCI, and the signaling carried by PDSCH for transmission to the user equipment. In some cases, the SSB index and CSI-RS index may be carried in the DCI for sending to the user equipment, while the SSB parameter and CSI-RS parameter may be carried in the RRC signaling for sending to the user equipment. Here, since the RRC signaling is used to carry only the SSB parameter or the CSI-RS parameter, the payload is relatively small, thereby reducing the system signaling overhead.

For example, the second indication information may be carried in the DCI for sending to the user equipment, so as to enable flexible configuration of the beam training.

In an embodiment, still referring to FIG. 3, after S301, the user equipment may further perform S302 to carry out the beam training, thereby determining at least one of the reception beam or transmission beam of the user equipment.

S302: performing, according to the second indication information, beam training based on the information of the at least one transmission beam.

In an embodiment, after the user equipment acquires the second indication information through S301, the user equipment may respond to the indication and perform the beam training based on at least one transmission beam of the target cell, so as to determine at least one of the reception beam or the transmission beam. For example, the at least one transmission beam of the target cell may be a wide beam, and the reception beam and transmission beam of the user equipment may be narrow beams, where a beamwidth of the wide beam is greater than that of the narrow beam. The user equipment performs S302 to carry out the beam training according to the wide beam to obtain the narrow beam, i.e., at least one of the reception beam and transmission beam obtained through training.

In an embodiment, during the beam training process of S302, the user equipment may use different reception beams to measure reference signals on the transmission beams of different target cells, so as to obtain measurement results of different reception beams, such as Layer 1 Reference Signal Received Power (L1-RSRP), Layer 1 Signal to Interference plus Noise Ratio (L1-SINR), etc. Then, the user equipment determines the reception beam (e.g., the optimal reception beam) according to the measurement results. In this case, the reception beam is the reception beam obtained through training.

In an embodiment, after obtaining the reception beam through training, the user equipment may also determine the transmission beam paired with the reception beam as the transmission beam of the user equipment, and this transmission beam may be used to send uplink information to the target cell. In some cases, the above transmission beam determined according to the reception beam obtained through training may be described as the transmission beam obtained through beam training, i.e., the trained transmission beam. After S302, the user equipment may also send uplink information using the trained transmission beam.

In an embodiment, the above-mentioned uplink information may be uplink control information, uplink data, and the like. For example, when there is no uplink data, the user equipment may, after handing over to the target cell, use the above transmission beam of the user equipment to send uplink control information to the network device, such as handover response information or handover complete information, to indicate that the user equipment completes the cell handover. Alternatively, when there is uplink data, the user equipment may, after handing over to the target cell, use the above transmission beam of the user equipment to send the uplink data to the network device, so as to indicate that the user equipment completes the cell handover. Alternatively, the user equipment may, after handing over to the target cell, first use the above transmission beam of the user equipment to send the uplink control information to the network device to indicate the network device that the handover has been completed, and then send the uplink data to the network device using the above transmission beam of the user equipment when the uplink data arrives. In the embodiments of the present disclosure, the user equipment triggers the beam training through the second indication information. In this way, after handing over to the target cell, the user equipment communicates with the target cell using the trained beam.

In an embodiment, still referring to FIG. 3, after S302, the user equipment may further perform S303 to S304 to carry out the cell handover, such that the user equipment hands over to the target cell.

S303: receiving system information of the target cell;

S304: handing over from a serving cell to the target cell according to the system information of the cell.

In an embodiment, the user equipment may determine a reception beam according to at least one transmission beam of the target cell. In this case, the reception beam may not be the optimal reception beam obtained through the beam training, but may be any one of the plurality of reception beams obtained after performing beam scanning. Then, the user equipment receives the system information of the target cell using the reception beam, thereby performing uplink synchronization with the target cell, and subsequently handing over to the target cell.

It should be noted that S303 to S304 above are merely exemplary descriptions of the process of cell handover performed by the user equipment. In the actual handover process, there may also be other steps. The embodiments of the present disclosure are not specifically limited thereto.

In some cases, S302 and S303 to S304 may be executed sequentially or simultaneously. Unless otherwise contradictory, the embodiments of the present disclosure do not specifically limit the execution order of the steps.

In an embodiment, the second configuration information described above may also include time information (i.e., first time information), and the time information is used to indicate a time point (i.e., first time point), a time period (i.e., first time period), or a combination of the first time point and the first time period, at which the user equipment performs the beam training based on the information of the at least one transmission beam of the target cell. In S302, the user equipment responds to the second indication information and performs beam training according to the first time point or the first time period, so as to determine at least one of the reception beam or transmission beam of the user equipment. For example, the first time point may be a start time point, an end time point, or both the start and end time points at which the user equipment performs beam training. The first time period may be a time period during which the user equipment may perform the beam training.

In some cases, the first time information may include the start time point at which the user equipment performs the beam training, and thus, the user equipment may start performing the beam training at the start time point. Alternatively, the first time information may include the end time point at which the user equipment performs the beam training, and thus, the user equipment determines the start time point to start performing the beam training according to the end time point, and performs the beam training at the start time point. Alternatively, the first time information may include both the start and end time points for the user equipment to perform the beam training. In such a case, the user equipment may determine the time period (i.e., the first time period) for performing the beam training according to the start and end time points, and perform the beam training during this time period. In some cases, the first time information may include the time period during which the user equipment performs the beam training, and thus, the user equipment may perform the beam training during the first time period. In some cases, the first time information may include at least one of the above-mentioned start time point or the end time point, and the above-mentioned time period. In an embodiment, the start and end time points may be a start time point and an end time point of the time period, or may be any time point within the time period. The user equipment may perform the beam training during the time period according to the start time point or the end time point. Of course, the first time information may also include other time information related to performing the beam training. Accordingly, the user equipment may also adopt other manners to acquire the system information of the target cell according to the first time information. The embodiments of the present disclosure are not specifically limited thereto.

In an embodiment, the first time information mentioned above may also be carried in at least one of the following for transmission: an RRC signaling, a broadcast message, a system message, a medium access control (MAC) control element (CE), DCI, and a signaling carried by a PDSCH. For example, the first time information is carried in DCI for transmission.

In an embodiment, the respective pieces of information in the second configuration information may be carried in the same signaling for transmission or may be carried in different signaling for transmission. In some cases, the various pieces of information carried in different signaling may be transmitted simultaneously or multiple times. The embodiments of the present disclosure do not place any particular limitation on the transmission method of the second configuration information.

In an embodiment, the serving cell and the target cell of the user equipment may be cells managed by the same network device (e.g., ground station), or may be cells managed by different network devices. In some cases, different cells may communicate with the user equipment via different satellites, that is, the serving cell and the target cell may be served by different satellites. Of course, other deployment configurations of cells may also exist, and the present disclosure does not specifically limit this.

In an embodiment, the serving cell and the target cell of the user equipment may have the same PCI, or the serving cell and the target cell of the user equipment may have different PCIs.

In the embodiments of the present disclosure, the serving cell (or source cell) and the target cell of the user equipment are served by different satellites, and the target cell and the serving cell share the same PCI. When the user equipment hands over from the serving cell to the target cell, due to the same PCI, the user equipment may determine only a beam handover is performed. Thus, the user equipment triggers the beam training through the second indication information and uses the beam obtained through beam training to send the uplink information. In this way, after handing over to the target cell, the user equipment may communicate with the target cell using the trained beam.

It should be noted that the embodiments of S301 above may be executed independently. The embodiments of S301 may also be executed in combination with the embodiments of S302. The embodiments of S301 may also be executed in combination with the embodiments of S302 and the step of the user equipment sending the uplink information using the trained transmission beam. The embodiments of S301 may also be executed in combination with the embodiments of S302, the embodiments of S303 to S304, and the step of the user equipment sending the uplink information using the trained transmission beam. The embodiments of S303 to S304 may also be executed independently. Each step in the above embodiments may be executed independently or in combination. Unless otherwise contradictory, the execution order of each step may be exchanged arbitrarily.

In some embodiments, FIG. 4 is a schematic flow diagram of a third embodiment of the method for the cell handover performed by the user equipment side according to the embodiment of the present disclosure. The method for the cell handover may be applied to the user equipment of the above-described communication system. Referring to FIG. 4, the method for the cell handover may include S401 to S404.

S401: acquiring first configuration information and second configuration information of a target cell.

The first configuration information includes first indication information, the first indication information is configured to indicate the user equipment to acquire system information of the target cell. The second configuration information includes information of at least one transmission beam of the target cell and second indication information, and the second configuration information is configured to indicate the user equipment to perform beam training based on the information of the at least one transmission beam.

S402: performing, according to the second indication information, beam training based on the information of the at least one transmission beam.

S403: receiving system information of the target cell using a reception beam obtained through training, according to the first indication information.

S404: handing over from the serving cell to the target cell according to the system information of the target cell.

In an embodiment, after the user equipment obtains the reception beam through the beam training in S402, in response to the first indication information, the user equipment uses the reception beam obtained through training to receive the system information. Thus, since the reception beam obtained through training is the optimal reception beam, the user equipment may more reliably receive the system information of the target cell, thereby improving the success rate of receiving the system information.

It should be noted that the specific description of S401 may be referred to in the description of S201 in FIG. 2 and the description of S301 in FIG. 3. The specific description of S402 may be referred to in the description of S302 in FIG. 3. The specific description of S404 may be referred to in the description of S203 in FIG. 2. For the sake of brevity in the specification, repeated details are omitted here.

In an embodiment, in S401, the first configuration information and the second configuration information may be carried in the same signaling for transmission or may be carried in different signaling for transmission. In some cases, the first configuration information and the second configuration information carried in different signaling may be sent simultaneously or multiple times. The embodiments of the present disclosure do not impose specific limitations on the manner in which the first configuration information is sent.

In an embodiment, the first time information in the above-mentioned first configuration information and the second time information in the above-mentioned second configuration information may be the same time information, and the time information may indicate at least one of a time point or a time period at which the user equipment acquires the system information of the target cell, and may also indicate at least one of a time point or a time period at which the user equipment performs beam training based on the information of the at least one transmission beam of the target cell. In some cases, the above-mentioned time information may be separately carried in the first configuration information and the second configuration information, and thus may be referred to as first time information and second time information.

In an embodiment, the above-mentioned first configuration information and second configuration information may be included in the same configuration information, and the configuration information may include only one time information. In this case, the first time information and the second time information are the same information. Thus, the user equipment may trigger both the operation of acquiring the system information of the target cell and the operation of training the beam according to one configuration information of the network device, thereby reducing the signaling overhead of the system.

In an embodiment, after obtaining the reception beam through the training of S402, the user equipment may further determine the transmission beam paired with the reception beam as the transmission beam of the user equipment, and the transmission beam may be used to send uplink information to the target cell, so as to indicate to the network device that the user equipment completes the cell handover. In some cases, the transmission beam determined according to the reception beam obtained through training may be described as the transmission beam obtained through the beam training, i.e., the trained transmission beam. Thus, after S404, the user equipment may further use the trained transmission beam to send the uplink information to indicate that the user equipment completes the cell handover.

In an embodiment, the above-mentioned uplink information may be uplink control information, uplink data, and the like. For example, when there is no uplink data, the user equipment may, after S404, use the above transmission beam of the user equipment to send the uplink control information to the network device, such as handover response information, handover complete information, etc., to indicate that the user equipment completes the cell handover. Alternatively, when there is uplink data, the user equipment may, after S404, use the above transmission beam of the user equipment to send the uplink data to the network device to indicate that the user equipment completes the cell handover. Alternatively, the user equipment may, after S404, first use the above transmission beam of the user equipment to send the uplink control information to the network device to indicate the network device that the handover has been completed, and then send the uplink data to the network device using the above transmission beam of the user equipment when the uplink data arrives. As such, the user equipment completes the cell handover process. In the embodiments of the present disclosure, the user equipment triggers the beam training through the second indication information. In this way, after handing over to the target cell, the user equipment communicates with the target cell using the trained beam.

In an embodiment, the serving cell and the target cell of the user equipment may be cells managed by the same network device (e.g., ground station), or may be cells managed by different network devices. In some cases, different cells may communicate with the user equipment via different satellites, that is, the serving cell and the target cell may be served by different satellites. Of course, other deployment configurations of cells may also exist, and the present disclosure does not specifically limit this.

In an embodiment, the serving cell and the target cell of the user equipment may have the same Physical Cell Indicator (PCI), or the serving cell and the target cell of the user equipment may have different PCIs.

In the embodiments of the present disclosure, the serving cell (or source cell) and the target cell of the user equipment are served by different satellites, and the target cell and the serving cell share the same PCI. When the user equipment hands over from the serving cell to the target cell, due to the same PCI, the user equipment may determine only a beam handover is performed, that is, the user equipment thinks that the system information broadcast by the cell has not changed. Therefore, when the system information (e.g., SIB19) broadcast by the serving cell remains valid, the user equipment does not reacquire the system information. However, in fact, the system information of the target cell may have already changed (as the target and serving cells belong to two different satellites). Therefore, in the case that the current system information of the serving cell remains valid or unchanged, the serving cell needs to indicate to the user equipment to acquire the system information of the cell, such that the user equipment may perform the cell handover according to valid system information, so as to successfully hand over to the target cell. Furthermore, the user equipment triggers the beam training through the second indication information and uses the beam obtained through the beam training to send the uplink information. In this way, after handing over to the target cell, the user equipment may communicate with the target cell using the trained beam.

It should be noted that the embodiments of the steps of the above method for the cell handover may be executed independently or in combination with any of the embodiments in FIG. 2 to FIG. 3.

It should be noted that the embodiments of S401 to S404 described above may be executed independently. The embodiments of S401 to S404 may also be executed in combination with the step in which the user equipment uses the transmission beam obtained through training to send the uplink information. Each step in the above embodiments may be executed independently or in combination. Unless otherwise contradictory, the execution order of each step may be exchanged arbitrarily.

In some embodiments, the present disclosure further provides a solution for a cell handover, which may be applied to a user equipment in the above-mentioned communication system. The method for the cell handover may include the following steps:
step 1, acquiring configuration information of a target cell, where the configuration information is configured for the user equipment to hand over to the target cell.
step 2, handing over a serving cell to the target cell according to the configuration information.

In an embodiment, step 1 may include: acquiring first configuration information. In this case, the specific description of step 1 may be referred to the description of S201 in FIG. 2, and is omitted here for brevity.

In another embodiment, step 1 may include: acquiring second configuration information. In this case, the specific description of step 1 may also be referred to the description of S301 in FIG. 3, and is omitted here for brevity.

In yet another embodiment, step 1 may include: acquiring both the first configuration information and the second configuration information. In this case, the specific description of step 1 may also be referred to the description of S401 in FIG. 4, and is omitted here for brevity.

In an embodiment, step 2 may include: receiving system information of the target cell according to the first indication information; and handing over from the serving cell to the target cell according to the system information of the target cell. In this case, the specific description of step 2 may be referred to the description of S202 to S203 in FIG. 2, and is omitted here for brevity.

In another embodiment, step 2 may include: performing beam training based on the information of the at least one transmission beam according to the second indication information; receiving the system information of the target cell; and handing over from the serving cell to the target cell according to the system information of the cell. In this case, the specific description of step 2 may be referred to the description of S302 to S304 in FIG. 3, and is omitted here for brevity.

In yet another embodiment, step 2 may include: performing beam training based on the information of the at least one transmission beam according to the second indication information; receiving system information of the target cell using a reception beam obtained through training according to the first indication information; and handing over from the serving cell to the target cell according to the system information of the target cell. In this case, the specific description of step 2 may be referred to the description of S402 to S404 in FIG. 4, and is omitted here for brevity.

It should be noted that the embodiments of the steps of the above-mentioned method for the cell handover may be executed independently, or may be executed in combination with any one of the embodiments in FIGS. 2 to 4.

It should be noted that each of step 1 to step 2 described above may be executed independently, or may be executed in combination. The execution order of each step may be arbitrarily exchanged unless otherwise contradictory.

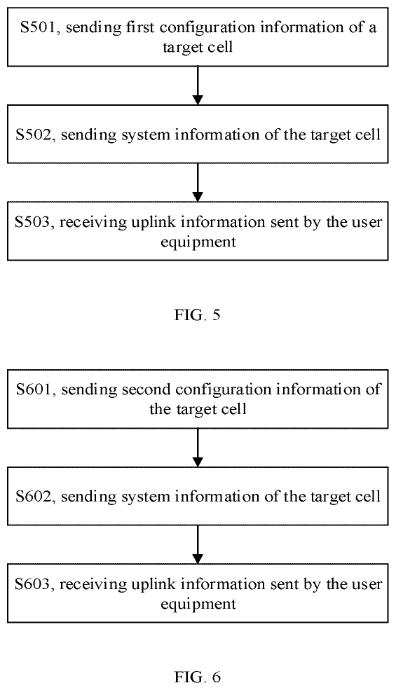

In some embodiments, FIG. 5 is a schematic diagram of a first implementation flow of a method for a cell handover performed by a network device side according to an embodiment of the present disclosure. The method for the cell handover may be applied to a network device in a communication system, such as a base station. Referring to FIG. 5, the method for the cell handover may include S501.

S501, sending first configuration information of a target cell.

The first configuration information includes first indication information, and the first indication information is configured to indicate the user equipment to acquire system information of the target cell, the system information is configured for the user equipment to hand over to the target cell.

In an embodiment, the first configuration information may be sent to the user equipment by a serving cell, or the first configuration information may be sent to the user equipment by a network device via the serving cell.

In an embodiment, the first configuration information may be carried in a high-layer signaling and sent to the user equipment, such as at least one of an RRC signaling, a broadcast message, a system message, an MAC CE, DCI, and a signaling carried by a PDSCH. Of course, the first configuration information may also be sent in another signaling. The embodiments of the present disclosure are not specifically limited thereto. For example, the first indication information is carried in the DCI and sent to the user equipment to achieve flexible configuration of beam training.

In some cases, the first configuration information may be sent separately by the network device, or may be sent together when the network device sends other information. For example, the first configuration information may be sent together with the configuration information of a reference signal sent by the network device.

In an embodiment, the above-mentioned system information may be one or more SI for the cell handover. For example, the system information may include a SIB19. SIB 19 includes satellite assistance information, such as ephemeris data, a public TA parameter, a koffset, a validity period of uplink synchronization information, an epoch time, and the like. Of course, the above system information may also include other SIBs, such as SIB1, SIBx, etc. The embodiments of the present disclosure are not specifically limited thereto.

As an example, the first indication information is configured to indicate the user equipment to acquire the SIB19.

In an embodiment, the first configuration information may further include time information (i.e., second time information), and the time information is configured to indicate a time point (i.e., second time point), a time period (i.e., second time period), or a combination of the second time point and the second time period for the user equipment to acquire the system information of the target cell. In response to the first indication information, the user equipment may receive the system information of the target cell according to the second time point or the second time period. For example, the second time point may be a start time point, an end time point, or a combination of the start time point and the end time point for the user equipment to acquire the system information of the target cell. The second time period may be a time period during which the user equipment may acquire the system information of the target cell.

In some cases, the second time information may include the start time point at which the user equipment acquires the system information of the target cell, and then, the user equipment may start receiving the system information of the target cell at the start time point. Alternatively, the second time information may include the end time point at which the user equipment acquires the system information of the target cell, the user equipment determines the start time point at which the user equipment starts to receive the system information of the target cell according to the end time point, and receives the system information of the target cell at the start time point. Alternatively, the second time information may include both the start time point and the end time point for the user equipment to acquire the system information of the target cell, the user equipment may determine the time period (i.e., second time period) used for acquiring the system information of the target cell according to the start time point and the end time point, and acquire the system information of the target cell during this time period. In some cases, the second time information may include the time period during which the user equipment acquires the system information of the target cell, and thus the user equipment may acquire the system information of the target cell during the second time period. In some cases, the second time information may include at least one of the above-mentioned start time point, end time point, or time period. In an embodiment, the start time point and the end time point may be start and end time points of the time period, or any time point within the time period. The user equipment may acquire the system information of the target cell during the time period according to the start time point or the end time point. Of course, the second time information may also include other time information related to acquiring the system information of the target cell. Correspondingly, the user equipment may also acquire the system information of the target cell according to the second time information in other manners. The embodiments of the present disclosure are not specifically limited thereto.

In an embodiment, the above-mentioned second time information may also be carried in at least one of an RRC signaling, a broadcast message, a system message, a Medium Access Control Control Element (MAC CE), DCI, and a signaling carried by a PDSCH for transmission. For example, the second time information is carried in the DCI for transmission.

In an embodiment, the respective pieces of information in the first configuration information may be carried in the same signaling for transmission or may be carried in different signaling for transmission. In some cases, the various pieces of information carried in different signaling may be transmitted simultaneously or multiple times. The embodiments of the present disclosure do not place any particular limitation on the manner in which the first configuration information is sent.

In some embodiments, still referring to FIG. 5, after S501, the network device may further perform S502 to send the system information of the target cell to the user equipment.

S502, sending system information of the target cell.

In an embodiment, the network device may send the system information of the target cell to the user equipment over a downlink channel such as a broadcast channel or a PDSCH and the like. Of course, the network device may also send the system information of the target cell to the user equipment via other means, which is not limited in the embodiments of the present disclosure.

In an embodiment, still referring to FIG. 5, after S501, the network device may further execute S503 to perform uplink communication with the user equipment.

S503, receiving uplink information sent by the user equipment.

The uplink information is configured to indicate that the user equipment completes the cell handover.

In an embodiment, in S503, the user equipment acquires the system information of the target cell based on the first configuration information and, after handing over to the target cell, the network device may communicate with the target cell. In this case, the network device receives the uplink information sent by the user equipment.

In an embodiment, the above-mentioned uplink information may be uplink control information, uplink data, and the like. For example, when there is no uplink data, after the user equipment hands over to the target cell, the network device may receive uplink control information, such as handover response information or handover complete information, to indicate that the user equipment completes the cell handover. Alternatively, when there is uplink data, after the user equipment hands over to the target cell, the network device may receive the uplink data to indicate that the user equipment completes the cell handover. Alternatively, after the user equipment hands over to the target cell, the network device may first receive uplink control information to indicate the completion of the handover to the network device, and then, when the uplink data arrives at the user equipment, the network device may receive the uplink data.

In an embodiment, the serving cell and the target cell of the user equipment may be cells managed by the same network device (e.g., ground station), or may be cells managed by different network devices. In some cases, different cells may communicate with the user equipment via different satellites, that is, the serving cell and the target cell may be served by different satellites. Of course, other deployment configurations of cells may also exist, and the present disclosure does not specifically limit this.

In an embodiment, the serving cell and the target cell of the user equipment may have the same Physical Cell Indicator (PCI), or the serving cell and the target cell of the user equipment may have different PCIs.

In the embodiments of the present disclosure, the serving cell (or source cell) and the target cell of the user equipment are served by different satellites, and the target cell and the serving cell share the same PCI. When the user equipment hands over from the serving cell to the target cell, due to the same PCI, the user equipment may determine only a beam handover is performed, that is, the user equipment thinks that the system information broadcast by the cell has not changed. Therefore, when the system information (e.g., SIB19) broadcast by the serving cell remains valid, the user equipment does not reacquire the system information. However, in fact, the system information of the target cell may have already changed (as the target and serving cells belong to two different satellites). Therefore, in the case that the current system information of the serving cell remains valid or unchanged, the serving cell needs to indicate to the user equipment to acquire the system information of the cell, such that the user equipment may perform the cell handover according to valid system information, so as to successfully hand over to the target cell.

It should be noted that the embodiment of S501, the embodiment of S502, and the embodiment of S503 described above may be executed independently. The embodiment of S501 may be executed in combination with the embodiment of S502. The embodiment of S501 may be executed in combination with the embodiment of S503. The embodiment of S501 may be executed in combination with the embodiments of both S502 and S503. Unless otherwise contradictory, each step in the above embodiments may be executed independently or in combination. The execution order of the steps may be exchanged arbitrarily.

It should be noted that the detailed descriptions of S501 to S503 may be referred to the description of the network device side in the embodiment of FIG. 2. In order to simplify the specification, they are not repeated here.

In some embodiments, FIG. 6 is a schematic diagram of a second implementation flow of a method for a cell handover performed on a network device side in an embodiment of the present disclosure. The method may be applied to a network device in a communication system, such as a base station. Referring to FIG. 6, the method for the cell handover may include S601.

S601, sending second configuration information of the target cell.

The second configuration information includes information of at least one transmission beam of the target cell and second indication information, where the second indication information is configured to indicate the user equipment to perform beam training based on the information of the at least one transmission beam.

In an embodiment, the second configuration information may be sent to the user equipment by the serving cell or may be sent to the user equipment by the network device via the serving cell.

In an embodiment, the information of the at least one transmission beam of the target cell may include configuration information of at least one reference signal of the target cell. The reference signal may be used for the user equipment to perform the beam training, and the reference signal may also be referred to as a training signal. In an embodiment, the at least one reference signal is sent by the target cell using the at least one transmission beam. In this case, the at least one transmission beam may be a wide beam or a beam with broad coverage.

In an embodiment, the above-mentioned reference signal may be an SS or a CSI-RS in the target cell. For example, when the user equipment is in an idle state, the beam training may be performed using the SS. When the user equipment is in a connected state, the beam training may be performed using the CSI-RS. Of course, in some cases, the reference signal may also be another signal sent using the transmission beam of the target cell, as long as the signals may be used for the beam training, which is not specifically limited by the embodiments of the present disclosure.

In an embodiment, the configuration information of the reference signal may include configuration information of the SS, such as configuration information of a Synchronization Signal Block (SSB), or configuration information of the CSI-RS. For example, the configuration information of the reference signal may include at least one of: an SSB index and an SSB parameter; or a CSI-RS index and a CSI-RS parameter.

In an embodiment, the second configuration information may be carried in high-layer signaling for transmission to the user equipment, such as at least one of an RRC signaling, broadcast messages, a system message, an MAC CE, DCI, and a signaling carried by a PDSCH. Of course, the second configuration information may also be carried in another signaling for transmission, which is not specifically limited by the embodiments of the present disclosure.

For example, the information of the at least one transmission beam may be carried in at least one of the RRC signaling, the broadcast message, the system message, the MAC CE, the DCI, and the signaling carried by PDSCH for transmission to the user equipment. In some cases, the SSB index and CSI-RS index may be carried in the DCI for sending to the user equipment, while the SSB parameter and CSI-RS parameter may be carried in the RRC signaling for sending to the user equipment. Here, since the RRC signaling is used to carry only the SSB parameter or the CSI-RS parameter, the payload is relatively small, thereby reducing the system signaling overhead.

For example, the second indication information may be carried in the DCI for sending to the user equipment, so as to enable flexible configuration of the beam training.

In an embodiment, the second configuration information described above may also include time information (i.e., first time information), and the time information is used to indicate a time point (i.e., first time point), a time period (i.e., first time period), or a combination of the first time point and the first time period, at which the user equipment performs the beam training based on the information of the at least one transmission beam of the target cell. The user equipment responds to the second indication information and performs beam training according to the first time point or the first time period, so as to determine at least one of the reception beam or transmission beam of the user equipment. For example, the first time point may be a start time point, an end time point, or both the start and end time points at which the user equipment performs beam training. The first time period may be a time period during which the user equipment may perform the beam training.

In some cases, the first time information may include the start time point at which the user equipment performs the beam training, and thus, the user equipment may start performing the beam training at the start time point. Alternatively, the first time information may include the end time point at which the user equipment performs the beam training, and thus, the user equipment determines the start time point to start performing the beam training according to the end time point, and performs the beam training at the start time point. Alternatively, the first time information may include both the start and end time points for the user equipment to perform the beam training. In such a case, the user equipment may determine the time period (i.e., the first time period) for performing the beam training according to the start and end time points, and perform the beam training during this time period. In some cases, the first time information may include the time period during which the user equipment performs the beam training, and thus, the user equipment may perform the beam training during the first time period. In some cases, the first time information may include at least one of the above-mentioned start time point or the end time point, and the above-mentioned time period. In an embodiment, the start and end time points may be a start time point and an end time point of the time period, or may be any time point within the time period. The user equipment may perform the beam training during the time period according to the start time point or the end time point. Of course, the first time information may also include other time information related to performing the beam training. Accordingly, the user equipment may also adopt other manners to acquire the system information of the target cell according to the first time information. The embodiments of the present disclosure are not specifically limited thereto.

In an embodiment, the first time information mentioned above may also be carried in at least one of the following for transmission: an RRC signaling, a broadcast message, a system message, a medium access control (MAC) control element (CE), DCI, and a signaling carried by a PDSCH. For example, the first time information is carried in DCI for transmission.

In an embodiment, the respective pieces of information in the second configuration information may be carried in the same signaling for transmission or may be carried in different signaling for transmission. In some cases, the various pieces of information carried in different signaling may be transmitted simultaneously or multiple times. The embodiments of the present disclosure do not place any particular limitation on the transmission method of the second configuration information.

In some embodiments, still referring to FIG. 6, after S601, the network device may also perform S602 to send system information of the target cell to the user equipment.

S602, sending system information of the target cell.

In an embodiment, the network device may send the system information of the target cell to the user equipment over a downlink channel such as a broadcast channel or a PDSCH and the like. Of course, the network device may also send the system information of the target cell to the user equipment via other means, which is not limited in the embodiments of the present disclosure.

In an embodiment, still referring to FIG. 6, after S601, the network device may also perform S603 to perform the uplink communication with the user equipment.

S603, receiving uplink information sent by the user equipment, where the uplink information is configured to indicate that the user equipment completes the cell handover.

In an embodiment, after obtaining the reception beam through training according to the second configuration information, the user equipment may further determine a transmission beam paired with the reception beam as the transmission beam of the user equipment, and the transmission beam may be used to send uplink information to the target cell, so as to indicate to the network device that the user equipment completes the cell handover. In some cases, the transmission beam determined based on the reception beam obtained through training may be described as a transmission beam obtained through beam training, i.e., a trained transmission beam.

In an embodiment, the above-mentioned uplink information may include uplink control information, uplink data, and the like. For example, when there is no uplink data, after the user equipment hands over to the target cell, the network device may receive the uplink control information that is sent by the user equipment through using the above-mentioned transmission beam of the user equipment, such as handover response information, handover complete information, and the like., to indicate that the user equipment completes the cell handover. Alternatively, when there is the uplink data, after the user equipment hands over to the target cell, the network device may receive the uplink data that is sent by the user equipment through using the above-mentioned transmission beam of the user equipment, to indicate that the user equipment completes the cell handover. Alternatively, after the user equipment hands over to the target cell, the network device may first receive the uplink control information that is sent using the above-mentioned transmission beam of the user equipment to indicate handover completion to the network device, and then, when the uplink data arrives at the user equipment, the network device may receive the uplink data sent using the above-mentioned transmission beam of the user equipment. In this embodiment of the present disclosure, the network device triggers the user equipment to perform the beam training through the second indication information, such that the user equipment may use the trained beam to communicate with the target cell after handing over to the target cell.

In an embodiment, the serving cell and the target cell of the user equipment may be cells managed by the same network device (e.g., ground station), or may be cells managed by different network devices. In some cases, different cells may communicate with the user equipment via different satellites, that is, the serving cell and the target cell may be served by different satellites. Of course, other deployment configurations of cells may also exist, and the present disclosure does not specifically limit this.

In an embodiment, the serving cell and the target cell of the user equipment may have the same Physical Cell Indicator (PCI), or the serving cell and the target cell of the user equipment may have different PCIs.

In this embodiment of the present disclosure, the serving cell (or source cell) and the target cell of the user equipment are served by different satellites, and the target cell and the serving cell have the same PCI. When the user equipment hands over from the serving cell to the target cell, due to the same PCI, the user equipment may consider that only a beam handover has been performed. Thus, the network device triggers the user equipment to perform the beam training through the second indication information, such that the user equipment may use the trained beam to communicate with the target cell after handing over to the target cell.

It should be noted that the above-mentioned embodiments of S601, S602, and S603 may each be executed independently. The embodiment of S601 may be executed in combination with the embodiment of S602. The embodiment of S601 may be executed in combination with the embodiment of S603. The embodiment of S601 may also be executed in combination with the embodiments of S602 and S603. Each step in the above embodiments may be executed independently or in combination. Unless otherwise contradictory, the execution order of each step may be arbitrarily exchanged.

It should be noted that the specific descriptions of S601 to S603 may be referred to the descriptions of the network device side in embodiments of FIG. 3. For brevity of the description, they will not be repeated here.

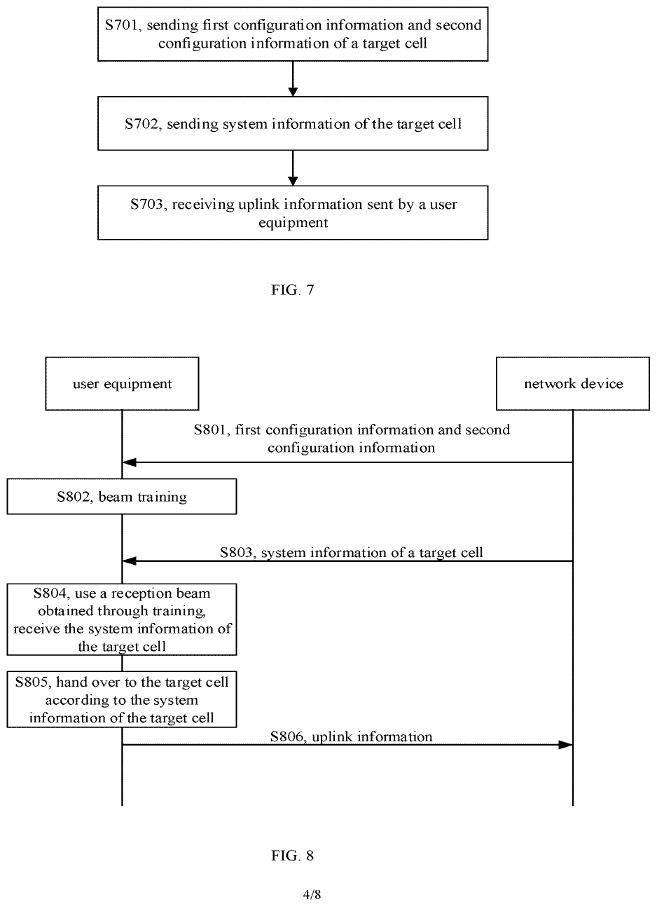

In some embodiments, FIG. 7 illustrates a schematic diagram of a third implementation flow of a method for a cell handover performed on a network device side in an embodiment of the present disclosure. The method for the cell handover may be applied to the above-mentioned network device of the communication system, such as a base station. Referring to FIG. 7, the method for the cell handover may include S701.

S701, sending first configuration information and second configuration information of a target cell.

The first configuration information includes first indication information, the first indication information is configured to indicate the user equipment to acquire system information of the target cell. The second configuration information includes information of at least one transmission beam of the target cell and second indication information, and the second configuration information is configured to indicate the user equipment to perform beam training based on the information of the at least one transmission beam.

S702, sending system information of the target cell.

S703, receiving uplink information sent by a user equipment, where the uplink information is configured to indicate that the user equipment completes the cell handover.

It should be noted that the embodiments of S701, S702, and S703 described above may each be executed independently. The embodiment of S701 may be executed in combination with the embodiment of S702. The embodiment of S701 may be executed in combination with the embodiment of S703. The embodiment of S701 may be executed in combination with the embodiments of S702 and S703. Each step in the above embodiments may be executed independently or in combination. Unless otherwise contradictory, the execution order of each step may be arbitrarily exchanged.

It should be noted that specific descriptions of S701 to S703 may be referred to the descriptions of the network device side in embodiments of FIG. 4. For the sake of brevity in the specification, they will not be repeated here.

It should be noted that the embodiments of the steps of the above method for the cell handover may be executed independently or in combination with any embodiment in FIG. 5 to FIG. 6.

In some embodiments, the embodiment of the present disclosure also provides a cell handover solution, and the method for the cell handover may be applied to the above network device of the communication system. The method for the cell handover may include the following steps:
step 3, sending configuration information of a target cell.
step 4, sending system information of the target cell.
step 5, receiving uplink information sent by a user equipment, the uplink information being configured to indicate that the user equipment completes the cell handover.

In an embodiment, the step 3 may include: sending first configuration information. Thus, the specific description of step 3 may be referred to the description of S501 in FIG. 5. For the sake of brevity in the specification, it will not be repeated here.

In another embodiment, step 3 may include: sending second configuration information. Thus, the specific description of step 3 may also be referred to the description of S601 in FIG. 6. For the sake of brevity in the specification, it will not be repeated here.

In yet another embodiment, step 3 may include: sending the first configuration information and the second configuration information. Thus, the specific description of step 3 may also be referred to the description of S701 in FIG. 7. For the sake of brevity in the specification, it will not be repeated here.

In an embodiment, the specific description of step 4 may be referred to the description of S502 in FIG. 5. For the sake of brevity in the specification, it will not be repeated here.

In another embodiment, the specific description of step 4 may be referred to the description of S602 in FIG. 6. For the sake of brevity in the specification, it will not be repeated here.

In yet another embodiment, the specific description of step 4 may be referred to the description of S702 in FIG. 7. For the sake of brevity in the specification, it will not be repeated here.

In an embodiment, the specific description of step 5 may be referred to the description of S503 in FIG. 5. For the sake of brevity in the specification, it will not be repeated here.

In another embodiment, the specific description of step 5 may be referred to the description of S603 in FIG. 6. For the sake of brevity in the specification, it will not be repeated here.

In yet another embodiment, the specific description of step 5 may be referred to the description of S703 in FIG. 7. For the sake of brevity in the specification, it will not be repeated here.

It should be noted that the embodiments of the steps of the above method for cell handover may be executed independently or in combination with any embodiment in FIG. 5 to FIG. 6.

It should be noted that each step among step 3 to step 5 may be executed independently or in combination. Unless otherwise contradictory, the execution order of the steps may be exchanged arbitrarily.

In an embodiment, the above cell handover method is further illustrated by a specific example below.

FIG. 8 illustrates a schematic diagram of an implementation flow of a method for a cell handover performed in a communication system according to an embodiment of the present disclosure. The method may be applied to the above communication system. Referring to FIG. 8, the method may include S801 to S806.

S801, a network device sends first configuration information and second configuration information;

S802, a user equipment performs beam training according to the second indication information;

S803, the network device sends system information of a target cell;

S804, the user equipment receives the system information of the target cell using a reception beam obtained through training according to first indication information;

S805, the user equipment hands over from a serving cell to the target cell according to the system information of the target cell;

S806, the user equipment sends uplink information to the network device to indicate completion of handover.

In an embodiment, the user equipment measures the L1-RSRP/L1-SINR corresponding to the SSB configuration or CSI-RS configuration using different reception beams according to the second indication information and configuration information of the reference signal, determines the reception beam, and completes the beam training;

In an embodiment, the user equipment measures the L1-RSRP/L1-SINR corresponding to the SSB configuration or CSI-RS configuration at a specified time according to the second indication information, the configuration information of the reference signal, and the second time information, determines the reception beam, and completes the beam training;

In an embodiment, the user equipment measures the L1-RSRP/L1-SINR corresponding to the SSB configuration or CSI-RS configuration according to the first indication information, the second indication information, and the configuration information of the reference signal, determines the reception beam, completes the beam training, and acquires the system information of the target cell;

In an embodiment, the user equipment measures the L1-RSRP/L1-SINR corresponding to the SSB configuration or CSI-RS configuration at a specified time according to the first indication information, the second indication information, the configuration information of the reference signal, and the time information, determines the reception beam, completes the beam training, and acquires the system information of the target cell at a specified time. According to the time information, the user equipment acquires the system information of the target cell at the specified time.

In the embodiments of the present disclosure, the serving cell (or source cell) and the target cell of the user equipment are served by different satellites, and the target cell and the serving cell share the same PCI. When the user equipment hands over from the serving cell to the target cell, due to the same PCI, the user equipment may determine only a beam handover is performed, that is, the user equipment thinks that the system information broadcast by the cell has not changed. Therefore, when the system information (e.g., SIB19) broadcast by the serving cell remains valid, the user equipment does not reacquire the system information. However, in fact, the system information of the target cell may have already changed (as the target and serving cells belong to two different satellites). Therefore, in the case that the current system information of the serving cell remains valid or unchanged, the serving cell needs to indicate to the user equipment to acquire the system information of the cell, such that the user equipment may perform the cell handover according to valid system information, so as to successfully hand over to the target cell. Furthermore, the user equipment triggers the beam training through the second indication information and uses the beam obtained through the beam training to send the uplink information. In this way, after handing over to the target cell, the user equipment may use the trained beam to communicate with the target cell.

It should be noted that the embodiments of S801 to S802 and the embodiments of S804 to S805 may be executed in combination. The embodiments of S801 to S805 may be executed in combination. The embodiments of S801 to S802, the embodiments of S804 to S805, and the embodiment of S806 may be executed in combination. Each step in the above embodiments may be executed independently or in combination. Unless otherwise contradictory, the execution order of the steps may be arbitrarily exchanged.

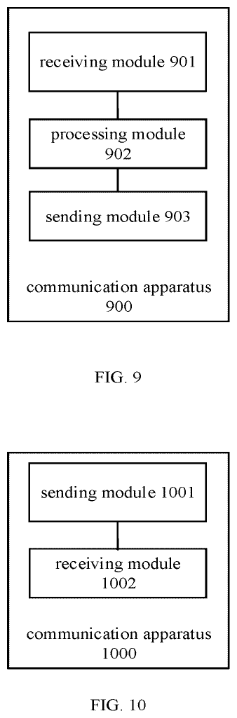

Based on the same inventive concept, the embodiments of the present disclosure further provide a communication device. FIG. 9 is a schematic diagram of a first structure of a communication apparatus in the embodiment of the present disclosure. The apparatus may be a user equipment in a communication system or a chip or system on chip within the user equipment, and may also be a functional module in the user equipment used to implement the method of the above embodiments. These functions may be implemented through hardware executing corresponding software. Such hardware or software includes one or more modules corresponding to the above functions. The communication apparatus 900 includes: a receiving module 901, configured to acquire configuration information of a target cell, where the configuration information is configured for a user equipment to hand over to the target cell.

In an embodiment, the receiving module 901 is configured to acquire first configuration information of the target cell, where the first configuration information includes first indication information, and the first indication information is configured to indicate the user equipment to acquire system information of the target cell, and the system information is configured for the user equipment to hand over to the target cell.

In an embodiment, the receiving module 901 is configured to acquire second configuration information of the target cell, where the second configuration information includes information of at least one transmission beam of the target cell and second indication information, and the second indication information is configured to indicate the user equipment to perform beam training based on the information of the at least one transmission beam.

In an embodiment, the apparatus 900 further includes: a processing module 902, configured to perform beam training based on the information of the at least one transmission beam according to the second indication information.

In an embodiment, the processing module 902 is configured to determine at least one of a reception beam or a transmission beam of the user equipment based on the information of the at least one transmission beam.

In an embodiment, the processing module 902 is configured to determine the transmission beam of the user equipment according to the reception beam obtained through training.

In an embodiment, the apparatus 900 further includes: a sending module 903, configured to send uplink information using the transmission beam of the user equipment, where the uplink information is configured to indicate that the user equipment completes the handover.

In an embodiment, the second configuration information further includes first time information, where the first time information is configured to indicate at least one of a first time point and a first time period during which the user equipment performs beam training based on the information of at least one transmission beam; correspondingly, the processing module 902 is further configured to perform beam training based on the information of at least one transmission beam at at least one of the first time point or the first time period.

In an embodiment, the receiving module 901 is further configured to receive the system information of the target cell using the reception beam obtained through training.

In an embodiment, the receiving module 901 is further configured to receive the system information according to the first indication information.

In an embodiment, the first configuration information further includes second time information, where the second time information is configured to indicate at least one of a second time point and a second time period for the user equipment to acquire the system information of the target cell; correspondingly, the receiving module 901 is further configured to receive the system information at at least one of the second time point or the second time period.

In an embodiment, the sending module 902 is configured to send uplink information, where the uplink information is configured to indicate that the user equipment completes the cell handover.

It should be noted that the specific implementation processes of the receiving module 901, the processing module 902, and the sending module 903 may refer to the detailed description of the user equipment in the above method embodiments. For the sake of brevity of the specification, details are not repeated here.

In the embodiments of the present disclosure, the receiving module 901 may be a receiving interface, a receiving circuit, or a receiver, etc.; the sending module 903 may be a sending interface, a sending circuit, or a sender, etc.; the processing module 902 may be one or more processors.

In some embodiments, the present disclosure further provides a communication apparatus. FIG. 10 is a schematic diagram of a second structure of the communication apparatus in an embodiment of the present disclosure. The apparatus may be a network device in a communication system or a chip or system on chip within the network device, and may also be a functional module in the network device used to implement the methods of the above embodiments. These functions may be implemented through hardware executing the corresponding software. Such hardware or software includes one or more modules corresponding to the above functions. Referring to FIG. 10, the communication apparatus 1000 may include: a sending module 1001, configured to send configuration information of a target cell, where the configuration information is configured for the user equipment to hand over to the target cell.

In an embodiment, the sending module 1001 is configured to send first configuration information of the target cell, where the first configuration information includes first indication information, and the first indication information is configured to indicate the user equipment to acquire system information of the target cell, and the system information is configured for the user equipment to hand over to the target cell.

In an embodiment, the sending module 1001 is configured to send second configuration information of the target cell, where the second configuration information includes information of at least one transmission beam of the target cell and second indication information, and the second indication information is configured to indicate the user equipment to perform beam training based on the information of at least one transmission beam.

In an embodiment, the second configuration information further includes: first time information, the first time information is configured to indicate at least one of a first time point and a first time period during which the user equipment performs beam training based on the information of at least one transmission beam.

In an embodiment, the configuration information further includes: second time information, the second time information is configured to indicate at least one of a second time point and a second time period during which the user equipment acquires system information of the target cell.

In an embodiment, the apparatus 1000 further includes: a receiving module 1002, configured to receive uplink information, where the uplink information is configured to indicate that the user equipment completes the cell handover.

It should be noted that the specific implementation processes of the sending module 1001 and the receiving module 1002 may refer to the detailed descriptions of the network device in the above method embodiments. For the sake of brevity of the specification, they are not repeated here.

In the embodiments of the present disclosure, the sending module 1001 may be a sending interface, a sending circuit, or a sender, etc.; the receiving module 1002 may be a receiving interface, a receiving circuit, or a receiver, etc.

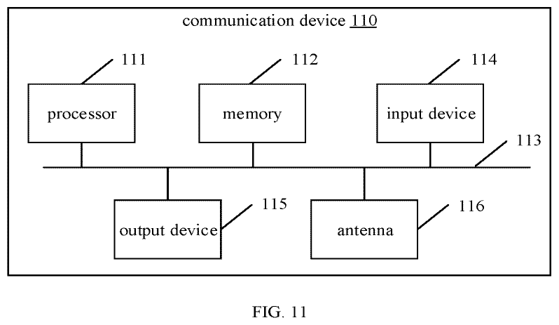

Based on the same inventive concept, embodiments of the present disclosure provide a communication device. The communication device may be the user equipment or the network device described in one or more of the above embodiments. FIG. 11 is a schematic diagram illustrating a communication device according to embodiments of the present disclosure. As illustrated in FIG. 11, the communication device 110 adopts a general computer hardware, including a processor 111, a memory 112, a bus 113, an input device 114, and an output device 115

In some embodiments, the memory 112 may include a computer storage media in a form of volatile and/or non-volatile memory, such as a read-only memory and/or a random access memory. The memory 112 may store an operating system, an application program, other program modules, an executable code, a program data, a user data, etc.

The input device 114 may be configured to input a command and an information to the communication device, for example, the input device 114 is a keyboard or a pointing device, such as a mice, a trackball, a touchpad, a microphone, a joystick, a game mat, a satellite TV antenna, a scanner, or similar devices. These input devices may be connected to the processor 111 through the bus 113.

The output device 115 may be configured to output an information for the communication device. In addition to a monitor, the output device 115 may also be other peripheral output devices, such as a speaker and/or a printing device, and these output devices may also be connected to the processor 111 through the bus 113.

The communication device may be connected to a network, such as a local area network (LAN), through an antenna 66. In a networked environment, computer executable instructions stored in a control device may be stored in a remote storage device, not limited to local storage.

When the processor 111 in the communication device executes an executable code or an application program stored in the memory 112, the communication device executes the method for the cell handover of a user equipment side or a network device side according to the above embodiments. A specific execution process is described in the above embodiments and will not be repeated here.

In an embodiment, the memory 112 stores computer-executable instructions for implementing the functions of the receiving module 901, the processing module 902, and the sending module 903 in FIG. 9. The functions/implementation processes of the receiving module 901, the processing module 902, and the sending module 903 in FIG. 9 may be implemented by the processor 111 in FIG. 11 calling the computer-executable instructions stored in the memory 112. The specific implementation process and the function refer to the relevant embodiments above.

In an embodiment, the memory 112 stores computer-executable instructions for implementing the functions of the sending module 1001 and the receiving module 1002 in FIG. 10. The functions/implementation processes of the sending module 1001 and the receiving module 1002 in FIG. 10 may be implemented by the processor 111 in FIG. 11 calling the computer-executable instructions stored in the memory 112. The specific implementation process and the function refer to the relevant embodiments above.

Based on the same inventive concept, embodiments of the present disclosure provide a user equipment that is consistent with the user equipment in one or more of the above embodiments. Optionally, the user equipment may include a mobile phone, a computer, a digital broadcasting user equipment, a message transceiver device, a game console, a tablet device, a medical device, a fitness device, a personal digital assistant, etc.

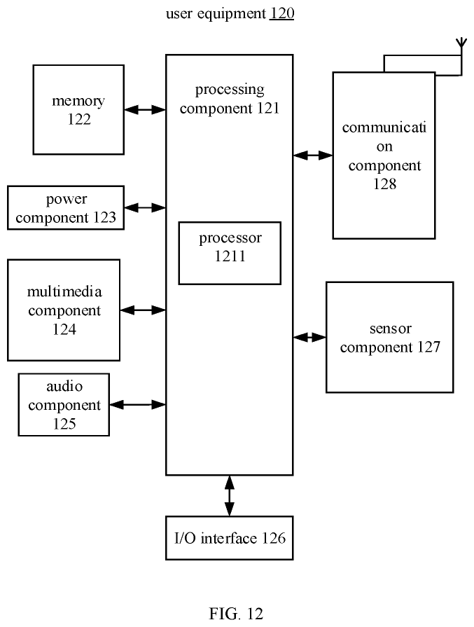

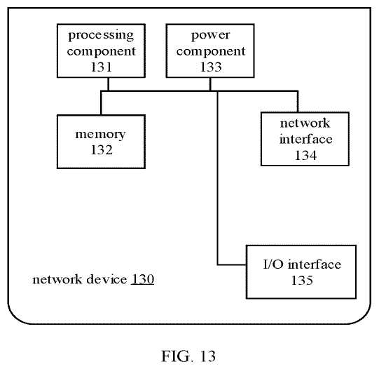

FIG. 12 is a schematic diagram illustrating a user equipment according to embodiments of the present disclosure. As illustrated in FIG. 12, a user equipment 120 may include one or more of following components: a processing component 121, a memory 122, a power component 123, a multimedia component 124, an audio component 125, an input/output (I/O) interface 126, a sensor component 127 and a communication component 128.

The processing component 121 typically controls the overall operation of the user equipment 120, such as operations associated with display, telephone calls, data communication, camera operations, and recording operations. The processing component 121 may include one or more processors 1211 to execute instructions to complete all or part of the steps of the above methods. In addition, the processing component 121 may include one or more modules to facilitate the interaction between the processing component 121 and other components. For example, the processing component 121 may include a multimedia module to facilitate interaction between the multimedia component 124 and the processing component 121.

The memory 122 is configured to store various types of data to support operations on the user equipment 120. Examples of these data include instructions for any application program or method operated on the user equipment 120, contact data, phone book data, messages, images, videos, etc. The memory 122 may be implemented by any type of volatile or non-volatile storage apparatus or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disc.

The power component 123 provides power to various components of the user equipment 120. The power component 123 may include a power management system, at least one power supply, and other components associated with generating, managing, and distributing power for the user equipment 120.

The multimedia component 124 includes a screen providing an output interface between the user equipment 120 and a user. In some embodiments, the screen may include a liquid crystal display (LCD) and a touch panel (TP). If the screen includes the touch panel, the screen may be implemented as a touch screen to receive input signals from the user. The touch panel includes at least one touch sensor to sense touches, slides and gestures on the touch panel. The touch sensor may not only sense the boundaries of the touch or slide action, but also detect the wake-up time and pressure associated with the touch or slide operation. In some embodiments, the multimedia component 124 includes a front-facing camera and/or a rear-facing camera. The front-facing camera and/or the rear-facing camera may receive external multimedia data when the user equipment 120 is in an operating mode, such as a shooting mode or a video mode. Each front-facing camera and rear-facing camera may be a fixed optical lens system or have a focal length and an optical zoom capability.

The audio component 125 is configured to output and/or input audio signals. For example, the audio component 125 includes a microphone (MIC) that is configured to receive external audio signals when the user equipment 120 is in the operating mode, such as a call mode, a recording mode, and a speech recognition mode. The received audio signals may be further stored in the memory 122 or transmitted through the communication component 128. In some embodiments, the audio component 125 further includes a speaker for outputting the audio signals.

The Input/output (I/O) interface 126 provides an interface between the processing component 121 and a peripheral interface module. The peripheral interface module may be a keypad, a click wheel, a button, and the like. These buttons may include, but are not limited to, a home button, a volume button, a start button, and a lock button.

The sensor component 127 includes at least one sensor for providing state assessments of various aspects for the user equipment 120. For example, the sensor component 127 may detect the on/off state of the user equipment 120, the relative positioning of components, such as a display and a keypad of the user equipment 120. The sensor component 127 may also detect the position change of the user equipment 120 or a component of the user equipment 120, the presence or absence of user contact with the user equipment 120, the orientation or acceleration/deceleration of the user equipment 120 and the temperature change of the user equipment 120. The sensor component 127 may include a proximity sensor configured to detect the presence of a nearby object without any physical contact. The sensor component 127 may also include an optical sensor, such as a CMOS or CCD image sensor, for use in imaging applications. In some embodiments, the sensor component 127 may also include an acceleration sensor, a gyroscope sensor, a magnetic sensor, a pressure sensor, or a temperature sensor.

The communication component 128 is configured to facilitate wired or wireless communication between the user equipment 120 and other apparatuses. The user equipment 120 may access to a wireless network based on a communication standard, such as Wi-Fi, 2G, 3G, 4G, or 5G, or a combination thereof. In an embodiment, the communication component 128 receives broadcast signals or broadcast-related information from an external broadcast management system via a broadcast channel. In an embodiment, the communication component 128 further includes a near field communication (NFC) module to facilitate short range communication. For example, NFC modules may be implemented based on Radio Frequency Identification (RFID) technology, Infrared Data Association (IrDA) technology, Ultra Wide Band (UWB) technology, Bluetooth (BT) technology and other technologies.

In an embodiment, the user equipment 120 may be implemented by at least one application specific integrated circuit (ASIC), digital signal processor (DSP), digital signal processing device (DSPD), programmable logic device (PLD), field programmable gate array (FPGA), controller, microcontroller, microprocessor, or another electronic element, for executing the above methods.

Based on the same inventive concept, embodiments of the present disclosure provide a network device that is consistent with the network device in one or more of the above embodiments.

FIG. 13 is a schematic diagram illustrating a network device according to embodiments of the present disclosure. As illustrated in FIG. 13, a network device 130 may include a processing component 131, which further includes one or more processors, and a memory resource, represented by a memory 132, for storing instructions, such as an application program, that may be executed by the processing component 131. The application program stored in the memory 132 may include one or more modules each corresponding to a set of instructions. In addition, the processing component 131 is configured to execute the instructions to execute any of the methods previously applied to the network device.

The network device 130 may also include a power component 133 configured to execute a power management for the network device 130, a wired or wireless network interface 134 configured to connect the network device 130 to the network, and an input/output (I/O) interface 135. The network device 130 may operate using an operating system stored in the memory 132, such as Windows Server™, Mac OS X™, Unix™, Linux™, FreeBSD™, or similar.

Based on the same inventive concept, embodiments of the present disclosure provide a communication device, such as a user equipment, including: an antenna; a memory; and a processor, where the processor is connected to the antenna and the memory, respectively, and configured to control the transmission and reception of the antenna by executing computer-executable instructions stored in the memory, and capable of implementing the method for the cell handover as described in one or more of the above embodiments.

Based on the same inventive concept, embodiments of the present disclosure provide a communication device, such as a network device, including: an antenna; a memory; and a processor, where the processor is connected to the antenna and the memory, configured to control the transmission and reception of the antenna by executing computer-executable instructions stored in the memory, and capable of implementing the method for the cell handover as described in one or more of the above embodiments.

Based on the same inventive concept, embodiments of the present disclosure provide a computer storage medium, where the computer storage medium stores computer-executable instructions, and the computer-executable instructions, when executed by a processor, are capable of implementing the method for the cell handover as described in one or more of the above embodiments.

Based on the same inventive concept, embodiments of the present disclosure provide a computer program or a computer program product, which, when performed on a computer, causes the computer to implement the method for the cell handover as described in one or more of the above embodiments.

According to a first aspect of the present disclosure, a method for a cell handover is provided, which may be applied to a user equipment in a communication system. The method includes: acquiring configuration information of a target cell, where the configuration information is configured for the user equipment to hand over to the target cell.

In some embodiments, acquiring the configuration information of the target cell includes: acquiring first configuration information of the target cell, where the first configuration information includes first indication information, the first indication information is configured to indicate the user equipment to acquire system information of the target cell, and the system information is configured for the user equipment to hand over to the target cell.

In some embodiments, acquiring the configuration information of the target cell includes: acquiring second configuration information of the target cell, where the second configuration information includes information of at least one transmission beam of the target cell and second indication information, and the second indication information is configured to indicate the user equipment to perform beam training based on the information of the at least one transmission beam.

In some embodiments, the method further includes: performing, according to the second indication information, beam training based on the information of the at least one transmission beam.

In some embodiments, performing the beam training based on the information of the at least one transmission beam includes: determining, based on the information of the at least one transmission beam, at least one of a reception beam or a transmission beam of the user equipment.

In some embodiments, determining the transmission beam based on the information of the at least one transmission beam includes: determining, according to a reception beam obtained through training, the transmission beam of the user equipment.

In some embodiments, the method further includes: sending uplink information using the transmission beam of the user equipment, where the uplink message is configured to indicate that the user equipment completes the handover.

In some embodiments, the second configuration information further includes first time information, the first time information is configured to indicate at least one of a first time point or a first time period for the user equipment to perform the beam training based on the information of the at least one transmission beam; where performing beam training based on the information of the at least one transmission beam includes: performing, at at least one of the first time point or the first time period, beam training based on the information of the at least one transmission beam.

In some embodiments, the information of the at least one transmission beam includes configuration information of at least one reference signal of the target cell.

In some embodiments, the at least one reference signal is a synchronization signal or a Channel Status Information Reference Signal in the target cell; the configuration information of the reference signal includes at least one of: an index of the synchronization signal and a parameter of the synchronization signal; or an index of the Channel Status Information Reference Signal and a parameter of the Channel Status Information Reference Signal.

In some embodiments, the method further includes: receiving the system information of the target cell using a reception beam obtained through training.

In some embodiments, the method further includes: receiving the system information according to the first indication information.

In some embodiments, the first configuration information further includes second time information, the second time information is configured to indicate at least one of a second time point or a second time period for the user equipment to acquire the system information of the target cell; where receiving the system information includes: receiving the system information at at least one of the second time point or the second time period.

In some embodiments, the method further includes: sending uplink information, where the uplink information is configured to indicate that the user equipment completes the cell handover.

In some embodiments, at least one of the first indication information and the second indication information is carried on downlink control information (DCI) for transmission.

In some embodiments, the target cell and a serving cell of the user equipment have a same physical cell indicator (PCI).

In some embodiments, the target cell and a serving cell of the user equipment belong to different satellites.

According to a second aspect of the present disclosure, a method for a cell handover is provided, which may be applied to a network device in a communication system. The method may include: sending configuration information of a target cell, where the configuration information is configured for the user equipment to hand over to the target cell.

In some embodiments, sending the configuration information of the target cell includes: sending first configuration information of the target cell, where the first configuration information includes first indication information, the first indication information is configured to indicate the user equipment to acquire system information of the target cell, and the system information is configured for the user equipment to hand over to the target cell.

In some embodiments, sending the configuration information of the target cell includes: sending second configuration information of the target cell, where the second configuration information includes information of at least one transmission beam of the target cell and second indication information, and the second indication information is configured to indicate the user equipment to perform beam training based on the information of the at least one transmission beam.

In some embodiments, the second configuration information further includes: first time information, which is configured to indicate at least one of a first time point or a first time period for the user equipment to perform beam training based on the information of the at least one transmission beam.

In some embodiments, the information of the at least one transmission beam includes configuration information of at least one reference signal of the target cell.

In some embodiments, the at least one reference signal is a synchronization signal or a Channel Status Information Reference Signal in the target cell; the configuration information of the reference signal includes at least one of the following: an index of the synchronization signal and a parameter of the synchronization signal; or an index of the Channel Status Information Reference Signal and a parameter of the Channel Status Information Reference Signal.

In some embodiments, the first configuration information further includes: second time information, which is configured to indicate at least one of a second time point or a second time period for the user equipment to acquire the system information of the target cell.

In some embodiments, at least one of the first indication information and the second indication information is carried on DCI for transmission.

In some embodiments, the method further includes: receiving uplink information, where the uplink information is configured to indicate that the user equipment completes the cell handover.

In some embodiments, a serving cell of the user equipment and the target cell have a same PCI.

In some embodiments, a serving cell of the user equipment and the target cell belong to different satellites.

According to a third aspect of the present disclosure, a communication apparatus is provided. The communication apparatus may be a user equipment or a chip or a system on chip in the user equipment in a communication system, and may also be a functional module in the user equipment configured to implement the method of the above embodiments. These functions may be implemented by hardware executing a corresponding software. The hardware or software includes one or more modules corresponding to the above functions. The communication apparatus includes: a receiving module, configured to acquire configuration information of a target cell, where the configuration information is configured for the user equipment to hand over to the target cell.

In some embodiments, the receiving module is configured to acquire first configuration information of the target cell, where the first configuration information includes first indication information, the first indication information is configured to indicate the user equipment to acquire system information of the target cell, and the system information is configured for the user equipment to hand over to the target cell.

In some embodiments, the receiving module is configured to acquire second configuration information of the target cell, where the second configuration information includes information of at least one transmission beam of the target cell and second indication information, and the second indication information is configured to indicate the user equipment to perform beam training based on the information of the at least one transmission beam.

In some embodiments, the apparatus further includes: a processing module, configured to perform beam training, according to the second indication information, based on the information of the at least one transmission beam.

In some embodiments, the processing module is configured to determine at least one of a reception beam or a transmission beam of the user equipment based on the information of the at least one transmission beam.

In some embodiments, the processing module is configured to determine the transmission beam of the user equipment according to a reception beam obtained through training.

In some embodiments, the apparatus further includes: a sending module, configured to send uplink information using the transmission beam of the user equipment, where the uplink information is configured to indicate that the user equipment completes the cell handover.

In some embodiments, the second configuration information further includes first time information, where the first time information is configured to indicate at least one of a first time point or a first time period for the user equipment to perform the beam training based on the information of the at least one transmission beam; and the processing module is further configured to perform the beam training at at least one of the first time point or the first time period based on the information of the at least one transmission beam.

In some embodiments, the receiving module is further configured to receive system information of the target cell using a reception beam obtained through training.

In some embodiments, the receiving module is further configured to receive the system information according to the first indication information.

In some embodiments, the first configuration information further includes second time information, which is configured to indicate at least one of a second time point or a second time period for the user equipment to acquire the system information of the target cell; and the receiving module is further configured to receive the system information at at least one of the second time point or the second time period.

In some embodiments, the apparatus further includes: sending uplink information, where the uplink information is configured to indicate that the user equipment completes the cell handover.

According to a fourth aspect of the present disclosure, a communication apparatus is provided, the communication apparatus may be a network device or a chip or a system on chip in the network device in a communication system, and may also be a functional module in the network device configured to implement the methods of the above embodiments. These functions may be implemented by hardware executing corresponding software. The hardware or software includes one or more modules corresponding to the above functions. The communication apparatus includes: a sending module, configured to send configuration information of a target cell, where the configuration information is configured for the user equipment to hand over to the target cell.

In some embodiments, the sending module is configured to send first configuration information of the target cell, where the first configuration information includes first indication information, the first indication information is configured to indicate the user equipment to acquire system information of the target cell, and the system information is configured for the user equipment to hand over to the target cell.

In some embodiments, the sending module is configured to send second configuration information of the target cell, where the second configuration information includes information of at least one transmission beam of the target cell and second indication information, and the second indication information is configured to indicate the user equipment to perform beam training based on the information of the at least one transmission beam.

In some embodiments, the second configuration information further includes: first time information, which is configured to indicate at least one of a first time point or a first time period for the user equipment to perform beam training based on the information of the at least one transmission beam.

In some embodiments, the first configuration information further includes: second time information, which is configured to indicate at least one of a second time point or a second time period for the user equipment to acquire the system information of the target cell.

In some embodiments, the apparatus further includes:

a receiving module, configured to receive uplink information, where the uplink information is configured to indicate that the user equipment completes the cell handover.

According to a fifth aspect of the present disclosure, a communication device, such as user equipment, is provided. The communication device includes: an antenna; a memory; and a processor, where the processor is connected to the antenna and the memory, respectively, and configured to control transmission and reception of the antenna by executing computer-executable instructions stored in the memory, and to implement the method for the cell handover according to any of the first aspect and embodiments thereof as disclosed herein.

According to a sixth aspect of the present disclosure, a communication device, such as a network device, is provided. The communication device includes: an antenna; a memory; and a processor, where the processor is connected to the antenna and the memory, respectively, and configured to control transmission and reception of the antenna by executing computer-executable instructions stored in the memory, and to implement the method for the cell handover according to any of the second aspect and embodiments thereof as disclosed herein.

According to a seventh aspect of the present disclosure, a computer storage medium is provided. The computer storage medium stores computer-executable instructions, where the computer-executable instructions, when executed by a processor, are configured to implement the method for the cell handover according to any of the first to second aspects and embodiments thereof as disclosed herein.

According to an eighth aspect of the present disclosure, a computer program or computer program product is provided. When the computer program product is performed on a computer, the computer is enabled to implement the method for the cell handover according to any of the first to second aspects and embodiments thereof as disclosed herein.

It should be understood that the fourth to eighth aspects of the present disclosure are consistent with the technical solutions of the first to third aspects of the present disclosure, and the beneficial effects achieved by the various aspects and corresponding embodiments thereof are similar and will not be described repeatedly.

Other embodiments of the present disclosure will easily occur to those skilled in the art after considering the specification and practicing the present disclosure disclosed herein. The present disclosure is intended to cover any variations, uses or adaptations of the present disclosure, which follow the general principles of the present disclosure and include common sense or common technical means in this technical field that are not disclosed in the present disclosure. The specification and embodiments are only considered illustrative, and the true scope and spirit of the present disclosure are indicated by the following claims.

It should be understood that the present disclosure is not limited to the precise structures described above and shown in the drawings, and various modifications and changes may be made without departing from its scope. The scope of the present disclosure is limited only by the scope of the appended claims.

1. A method for a cell handover, performed by a user equipment, comprising:
acquiring configuration information of a target cell, wherein the configuration information is configured for the user equipment to hand over to the target cell.

2. The method according to claim 1, wherein acquiring the configuration information of the target cell comprises:
acquiring first configuration information of the target cell, wherein the first configuration information comprises first indication information, the first indication information is configured to indicate the user equipment to acquire system information of the target cell, and the system information is configured for the user equipment to hand over to the target cell.

3. The method according to claim 1, wherein acquiring the configuration information of the target cell comprises:
acquiring second configuration information of the target cell, wherein the second configuration information comprises information of at least one transmission beam of the target cell and second indication information, and the second indication information is configured to indicate that the user equipment performs beam training based on the information of the at least one transmission beam.

4. The method according to claim 3, further comprising:
performing, according to the second indication information, the beam training based on the information of the at least one transmission beam.

5. The method according to claim 4, wherein performing the beam training based on the information of the at least one transmission beam comprises:
determining, based on the information of the at least one transmission beam, at least one of a reception beam or a transmission beam of the user equipment.

6. The method according to claim 5, wherein determining the transmission beam based on the information of the at least one transmission beam comprises:
determining, according to a reception beam obtained through training, the transmission beam of the user equipment.

7. The method according to claim 5, further comprising:
sending uplink information using the transmission beam of the user equipment, wherein the uplink information is configured to indicate that the user equipment completes the cell handover.

8. The method according to claim 4, wherein the second configuration information further comprises first time information, the first time information is configured to indicate at least one of a first time point or a first time period for the user equipment to perform the beam training based on the information of the at least one transmission beam;
wherein performing the beam training based on the information of the at least one transmission beam comprises:
performing, at at least one of the first time point or the first time period, the beam training based on the information of the at least one transmission beam.

9. The method according to claim 3, wherein the information of the at least one transmission beam comprises configuration information of at least one reference signal of the target cell;
wherein the at least one reference signal is a synchronization signal or a channel status information reference signal in the target cell; and the configuration information of the reference signal comprises at least one of:
an index of the synchronization signal and a parameter of the synchronization signal; or
an index of the channel status information reference signal and a parameter of the channel status information reference signal.

10. (canceled)

11. The method according to claim 2, further comprising:
receiving the system information of the target cell using a reception beam obtained through training.

12. The method according to claim 2, further comprising:
receiving the system information according to the first indication information;
wherein the first configuration information further comprises second time information, the second time information is configured to indicate at least one of a second time point or a second time period for the user equipment to acquire the system information of the target cell;
wherein receiving the system information comprises:
receiving the system information at at least one of the second time point or the second time period.

13. (canceled)

14. The method according to claim 12, further comprising:
sending uplink information, wherein the uplink information is configured to indicate that the user equipment completes the cell handover.

15. The method according to claim 1, wherein the target cell and a serving cell of the user equipment have a same physical cell indicator (PCI).

16. The method according to claim 1, wherein the target cell and a serving cell of the user equipment belong to different satellites.

17. A method for a cell handover, performed by a network device, comprising:
sending configuration information of a target cell, wherein the configuration information is configured for a user equipment to hand over to the target cell.

18. The method according to claim 17, wherein sending the configuration information of the target cell comprises:
sending first configuration information of the target cell, wherein the first configuration information comprises first indication information, the first indication information is configured to indicate the user equipment to acquire system information of the target cell, and the system information is configured for the user equipment to hand over to the target cell;
wherein the first configuration information further comprises second time information, and the second time information is configured to indicate at least one of a second time point or a second time period for the user equipment to acquire the system information of the target cell.

19. The method according to claim 17, wherein sending the configuration information of the target cell comprises:
sending second configuration information of the target cell, wherein the second configuration information comprises information of at least one transmission beam of the target cell and second indication information, and the second indication information is configured to indicate that the user equipment performs beam training based on the information of the at least one transmission beam;
wherein the second configuration information further comprises first time information, the first time information is configured to indicate at least one of a first time point or a first time period for the user equipment to perform the beam training based on the information of the at least one transmission beam;
wherein the information of the at least one transmission beam comprises configuration information of at least one reference signal of the target cell.

20-23. (canceled)

24. The method according to claim 17, further comprising:
receiving uplink information, wherein the uplink information is configured to indicate that the user equipment completes the cell handover.

25-40. (canceled)

41. A user equipment, comprising:
an antenna;
a memory;
a processor, connected to the antenna and the memory, respectively, and configured to:
control transmission and reception of the antenna by executing computer-executable instructions stored in the memory; and
acquire configuration information of a target cell, wherein the configuration information is configured for the user equipment to hand over to the target cell.

42. A network device, comprising:
an antenna;
a memory;
a processor, connected to the antenna and the memory, respectively, and configured to:
control transmission and reception of the antenna by executing computer-executable instructions stored in the memory; and
implement the method for the cell handover according to claim 17.

43. (canceled)
